(19) United States
(12) Patent Application Publication
(10) Pub. No.: US 2007/0006881 A1
(43) Pub. Date: Jan. 11, 2007

(54) Air-supply control device for air-pressure regulator

(76) Inventor: Hsing-Chi Hsieh, Taipei (TW)

Correspondence Address: PRO-TECHTOR INTERNATIONAL SERVICES, 20775 NORADA CT., SARATOGA, CA, 95070, US

(21) Appl. No.: 11/177,913

(22) Filed: Jul. 7, 2005

(51) Int. Cl. A62B 7/04

(52) U.S. Cl. 128/204.26

(57) ABSTRACT

An air supply control device includes a fixed sleeve mounted on and extended into an air-pressure regulator to communicate an external environment with an air passage in the regulator while the air passage is communicable with a mouthpiece, and a control plate and a push-button control unit mounted in the fixed sleeve with a front flat plate of the control plate extended across the air passage of the regulator. When the push-button control unit is axially pushed, the control plate is turned to different angular position to thereby change a sectional area of the air passage. A diver may therefore control the air volume supplied from the air-pressure regulator via the air passage to the diver depending on a diving depth simply by pushing the push-button control unit to different axial position.

### FIELD OF THE INVENTION

The present invention relates to an air supply control device, and more particularly to an air supply control device that can be easily pushed to adjust air volume supplied into an air-pressure regulator used by a diver.

### BACKGROUND OF THE INVENTION

Please refer to FIGS. 1 and 2. A general air-pressure regulator 10 for use in diving includes a case 11, and a rubber diaphragm 12 provided in the case 11 to separate an inner space of the case 11 from an outer side. When the rubber diaphragm 12 is subjected to an external pressure, i.e., water pressure, that is larger than an internal pressure, i.e., air pressure, of the air-pressure regulator 10, the rubber diaphragm 12 is deformed toward the inner space of the regulator 10 to press against an air-supply valve link 111 in the case 11 to thereby open an air-supply valve 112. When the air-supply valve 112 is opened, air in a diving air tank (not shown) is supplied via a through hole 113 on the air-supply valve 112 into the case 11 to increase the internal pressure of the case 11. When the internal pressure of the case 11 and the external pressure reach balance, the rubber diaphragm 12 is pushed by the increased internal pressure of the case 11 to its original position and the air-supply valve 112 is closed. A mouthpiece 114 is provided at one side of the case 11 to communicate with the inner space of the case 10 to form an air passage 115. The air supplied into the case 11 flows through the air passage 115 and the mouthpiece 114 to a diver's mouth (not shown) When the diver draws in air via the mouthpiece 114, air and accordingly air pressure inside the case 11 is reduced to cause unbalance between the internal pressure and the external pressure of the case 11, and the rubber diaphragm 12 is pressed by the higher external pressure against the link 111 to open the air-supply valve 112 again. Thus, the case 11 is automatically replenished with air.

Generally speaking, air density changes with diving depth. When the diving depth increases, the air density becomes higher while the air speed becomes slower. At this point, the diver tends to breathe quickly due to insufficient air supply. Reversely, when the diving depth decreases, the air density becomes lower while the air speed becomes quicker. At this point, the diver tends to choke with overly supplied air.

Therefore, it is necessary to provide an air supply control device in the air-pressure regulator 10 at the air passage 115 communicating with the mouthpiece 114, so that a sectional area of the air passage 115 could be timely adjusted to control the air volume supplied to the mouthpiece 114 within one unit of time, protecting the diver from being choked or breathing quickly.

As can be seen from FIGS. 1 and 2, a conventional air supply control device includes a control plate 20 having a round-sectioned connecting body 21, a flat plate 22, and a rotatable operating button 23. The connecting body 21 is fitted in a mounting hole 116 transversely provided at one side of the case 11 of the air-pressure regulator 10 to extend into and communicate with the air passage 115 inside the case 11. The flat plate 22 is connected to a front end of the connecting body 21 and extended into the air passage 115. When the flat plate 22 is turned, it changes a sectional area of the air passage 115 and accordingly the air volume that is allowed to flow through the air passage 115, as shown in FIG. 2. The rotatable operating button 23 is located outside the regulator 10 and connected to a rear end of the connecting body 21. When the diver turns the operating button 23, the flat plate 22 is turned at the same time to change the sectional area of the air passage 115, so that adequate amount of air is supplied to the diver.

More specifically, the flat plate 22 of the control plate 20 moves along with the rotatable operating button 23 to turn in the air passage 115. When the flat plate 22 is turned with its one side facing against a direction “a” in which the air flows through the air passage 115, as shown by the solid lines in FIG. 2, most part of the sectional area of the air passage 115 is blocked by the flat plate 22, so that the air volume that is allowed to flow through the air passage 115 is reduced. The air-pressure regulator 10 in this state is suitable for use at a relatively small diving depth to protect the diver from being choked with air flowing at high speed. Reversely, when the flat plate 22 is turned with its one edge facing against the direction “a”, as shown by the phantom lines in FIG. 2, only a small part of the sectional area of the air passage 115 is blocked by the flat plate 22, so that a relatively large volume of air is allowed to flow through the air passage 115. The air-pressure regulator 10 in this state is suitable for use at a relatively large diving depth to protect the diver from breathing quickly due to a slow air speed.

While the above-structured conventional air supply control device allows the diver to suitably regulate the supplied air volume depending on the diving depth, it does not include any means for the diver to recognize a current angular position of the flat plate 22 in the air passage 115. Therefore, the diver is not able to correctly control the turning direction of the control plate 20. Moreover, since the conventional air supply control device does not include any locating structure, the flat plate 22 tends to be unexpectedly turned to different angular position in the air passage 115 due to undesired external force applied thereto or improper touch of the flat plate 22, resulting in improper supply of air to the diver or causing confusion, inconvenience, or even panic to the diver to endanger the diver's safety.

It is therefore tried by the inventor to develop an improved air supply control device for the air-pressure regulator, so that a diver may easily regulate the air volume supplied to the air passage of the air-pressure regulator simply by pushing a control button to adjust the angular position of the control plate in the air passage.

### SUMMARY OF THE INVENTION

A primary object of the present invention is to provide an air supply control device for an air-pressure regulator, so that a diver may conveniently axially push a push-button control unit of the air supply control device to different extents for a control plate extended into an air passage in the air-pressure regulator to turn to different angular position to thereby change a sectional area of the air passage and accordingly the air volume supplied therethrough.

With the air supply control device of the present invention, a diver is able to control the air volume supplied by the air-pressure regulator to the diver depending on a diving depth. The air-pressure regulator includes a mouthpiece that is held in a diver's mouth. The mouthpiece communicates with an inner space of the air-pressure regulator to form an air passage. The air supply control device of the present invention includes a fixed sleeve mounted on the air-pressure regulator to extend into the air passage, and a control plate and a push-button control unit mounted in the fixed sleeve. When the push-button control unit is axially pushed, the control plate is turned to different angular position to thereby change a sectional area of the air passage and accordingly air volume supplied via the air passage.

The control plate is fitted in the fixed sleeve and adapted to turn between a first and a second angular position.

When the control plate is in the first angular position, the air passage in the air-pressure regulator has the smallest sectional area for reduced volume of air to flow therethrough; and when the control plate is in the second angular position, the air passage in the air-pressure regulator has the largest sectional area for increased volume of air to flow therethrough within one unit of time.

The push-button control unit may be pushed to axially move between a first and a second position to thereby turn the control plate between the first and the second angular position.

Whereby, when the push-button control unit is in the first position, the control plate is turned to the first angular position in the air passage of the air-pressure regulator; and when the push-button control unit is axially moved to the second position, the control plate is turned to the second angular position in the air passage. A diver may therefore conveniently push the push-button control unit to effectively adjust the control plate to different angular position. In this manner, the diver may easily regulate the air volume supplied to the mouthpiece via the air passage depending on a diving depth simply by pushing the push-button control unit to the first or the second position.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional air supply control device for air-pressure regulator;

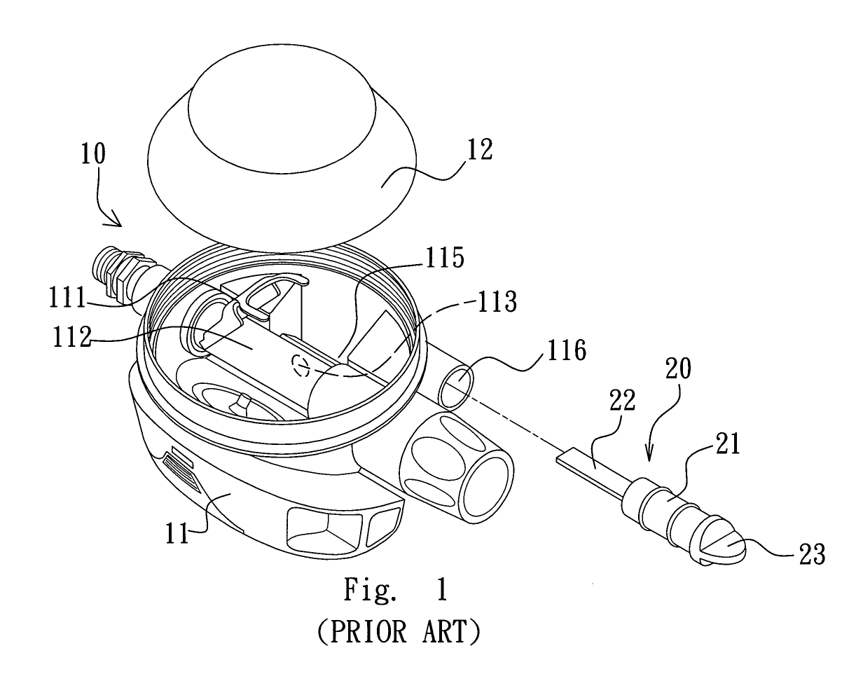

FIG. 2 is an assembled sectional view of the conventional air supply control device for air-pressure regulator of FIG. 1;

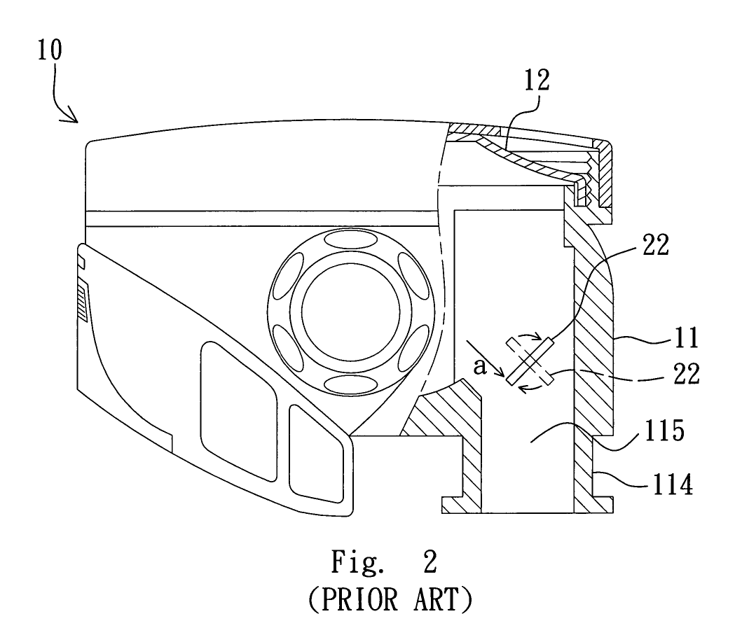

FIG. 3 is an exploded perspective view of an air supply control device for air-pressure regulator according to a first embodiment of the present invention;

FIG. 4 is an assembled sectional view of the air supply control device of FIG. 3 with a control button thereof in a first position;

FIG. 5 is another assembled sectional view of the air supply control device of FIG. 3 with the control button thereof in a second position;

FIG. 6 is an assembled sectional view of the air supply control device for air-pressure regulator of FIG. 3 taken along a plane passing through a flat plate of the control device; and

FIG. 7 is an assembled sectional view of the air supply control device for air-pressure regulator according to a second embodiment of the present invention.

### DETAILED DESCRIPTION OF THE PREFERRED EMBODIMENTS

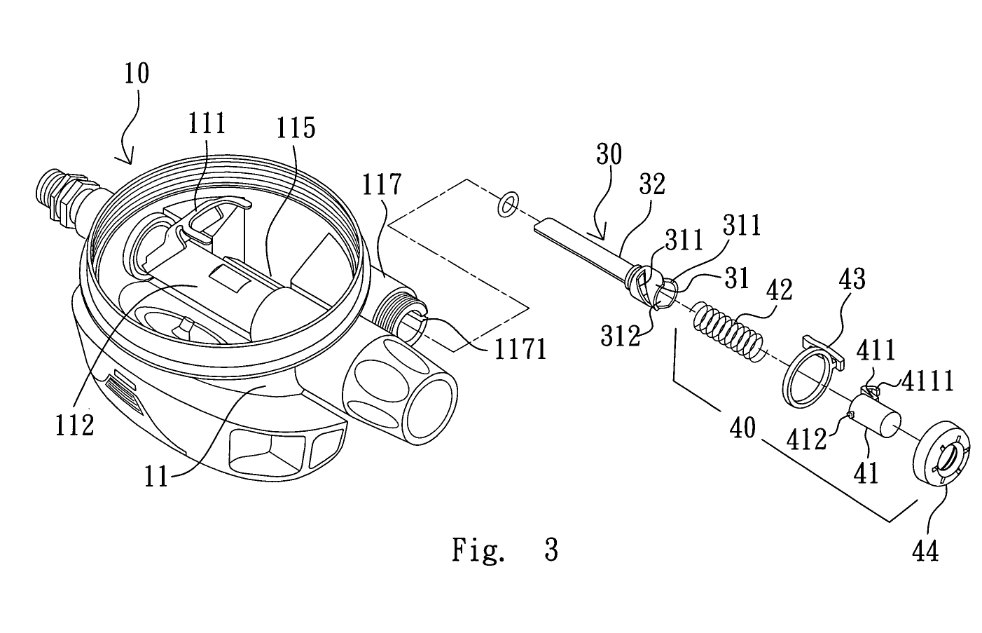

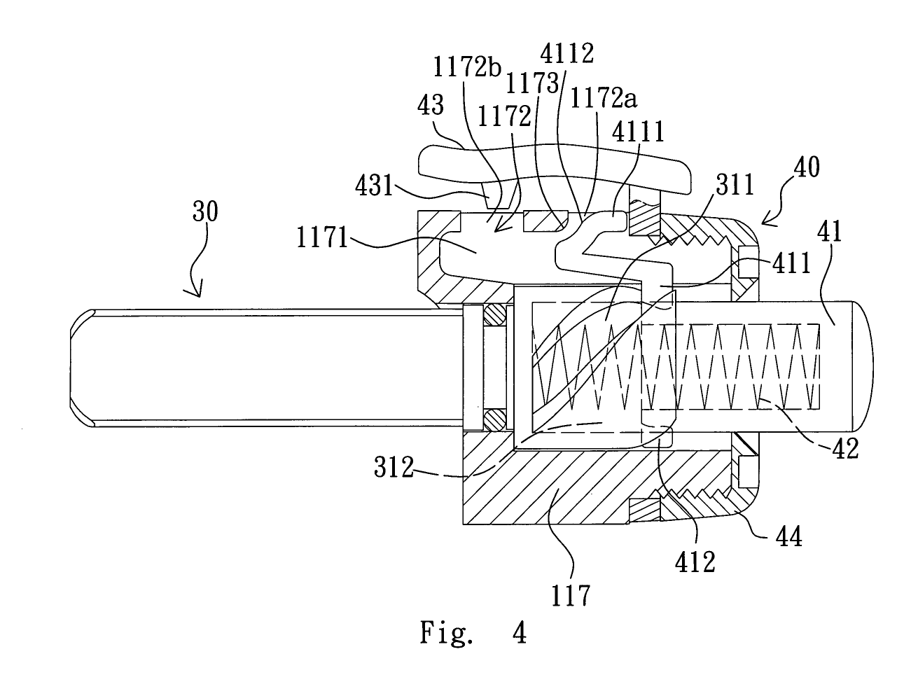

Please refer to FIGS. 3 and 4 that are exploded perspective view and assembled sectional view, respectively, of an air supply control device for air-pressure regulator according to a first embodiment of the present invention.

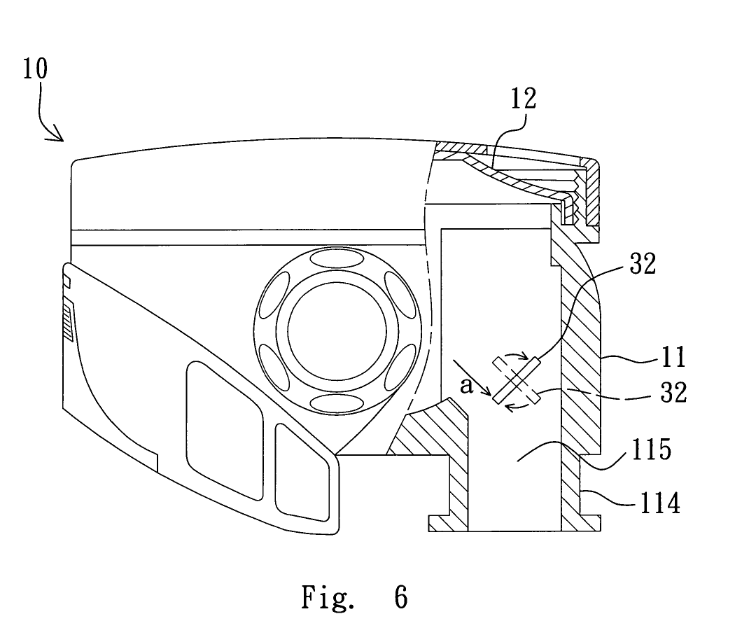

The air supply control device of the present invention is adapted to control the air volume supplied from an air-pressure regulator 10 to a mouthpiece 114 thereof depending on a diver's diving depth, so that the diver may draw in proper amount of air via the mouthpiece 114 of the air-pressure regulator 10. Please also refer to FIG. 6. The air-pressure regulator 10 internally includes an air passage 115 communicable with the mouthpiece 114, and externally includes a fixed sleeve 117, which extends through a wall of the air-pressure regulator 10 into the air passage 115. The fixed sleeve 117 is provided at one side with a longitudinal guide slot 1171, and a plurality of spaced locating holes 1172 arranged in the same direction as the guide slot 1171 to communicate with the guide slot 1171. In the first embodiment shown in FIGS. 3 and 4, there are two locating holes 1172, namely, a first-position locating hole 1172a and a second-position locating hole 1172b. The air supply control device of the present invention is mounted in the fixed sleeve 117 and includes a control plate 30 and a push-button control unit 40.

The control plate 30 includes a slotted annular body 31, and a flat plate 32 connected to a front end of the slotted annular body 31. The control plate 30 is fitted in the fixed sleeve 117 with the flat plate 32 extended across the air passage 115. When the flat plate 32 is turned to different angular position in the air passage 115, the size of a sectional area of the air passage 115 is changed to thereby regulate the volume of air that flows through the air passage 115. The slotted annular body 31 is provided on a wall thereof with a pair of spiral slots 311, and defines therein a channel 312 of a predetermined length. The channel 312 is communicable with the spiral slots 311, and the push-button control unit 40 is mounted in the channel 312 (see FIG. 3).

The push-button control unit 40 includes a control button 41, an elastic element 42, and a suspension arm 43.

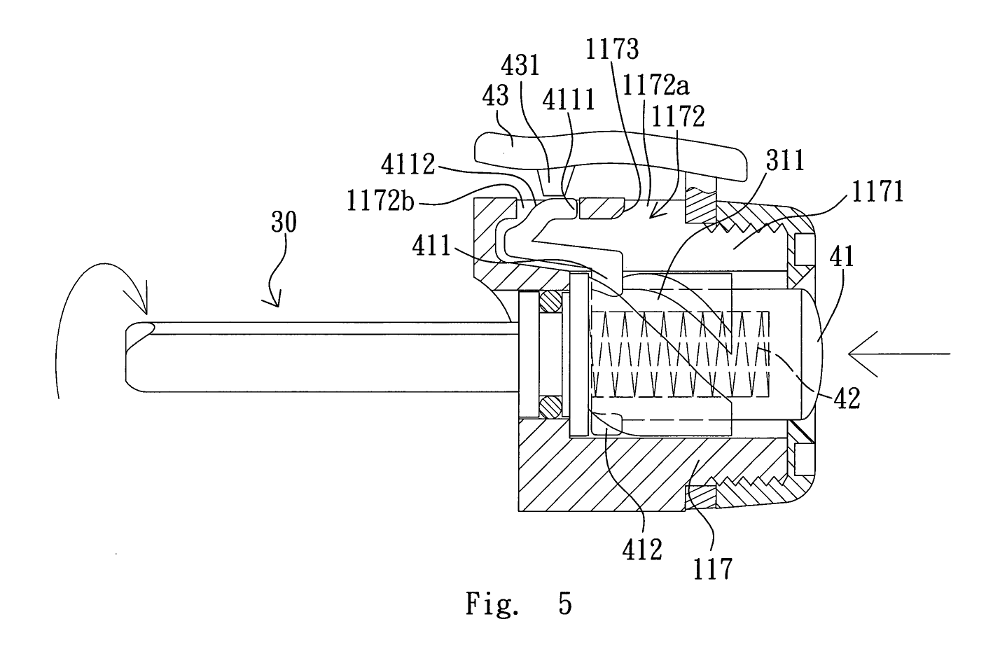

The control button 41 is received in the channel 312 of the annular body 31 of the control plate 30, and has a first and a second pusher 411, 412 extended from two opposite sides thereof. The first and the second pusher 411, 412 are separately engaged with the two spiral slots 311 on the annular body 31, such that when the control button 41 is pushed, the control plate 30 is correspondingly driven to rotate. The first pusher 411 includes an elastic plate 4111 backward extended from a front end of the first pusher 411. The elastic plate 4111 is slidable in the longitudinal guide slot 1171 on the fixed sleeve 117, allowing the control button 41 to slide in the extending direction of the longitudinal guide slot 1171 between the first-position and the second-position locating hole 1172a, 1172b. When the elastic plate 4111 is aligned with one of the locating holes 1172, it moves into the aligned locating hole 1172a or 1172b, so that the control button 41 is accurately located at a desired position to set the flat plate 32 of the control plate 30 to a desired angular position in the air passage 115, as shown in FIGS. 4 and 5.

The elastic element 42 is mounted between the channel 312 and the control button 41 to provide an elastic restoring force for the control button 41 to return from the second-position locating hole 1172b to the first position locating hole 1172a.

The suspension arm 43 is put around the fixed sleeve 117, and includes at least one push block 431 provided at a position corresponding to and facing toward the locating hole 1172. When it is desired to return the control button 41 to its initial or first position, simply press the push block 431 against the elastic plate 4111 engaged with the locating hole 1172, so that the elastic plate 4111 is deformed to move out of the locating hole 1172. The number of the push blocks 431 is decided depending on the quantity of the locating holes 1172.

The push-button control unit 40 also includes a cover 44, which is screwed to the fixed sleeve 117 to hold the control plate 30, the control button 41, the elastic element 42, and the suspension arm 43 in the fixed sleeve 117.

When the control button 41 is pushed for the push-button control unit 40 to move from the first position to the second position, the first and the second pusher 411, 412 at two sides of the control button 41 synchronously push the pair of spiral slots 311 on the slotted annular body 31, so that the flat plate 32 of the control plate 30 is turned from a first angular position to a second angular position. That is, the diver needs only to push the control button 41 to change the turning angle of the control plate 30, so that air volume supplied from the air-pressure regulator 10 to the diver via the air passage 115 and the mouthpiece 114 can be properly controlled depending on the diving depth.

Please refer to FIG. 6 that is a sectional view taken along a plane passing through the flat plate 32 of the control plate 30. When the air supply control device for air-pressure regulator according to the present invention is used at a relatively small diving depth, there is a lower air density and accordingly faster air speed. At this point, the diver may set the control button 41 of the push-button control unit 40 to the first position. In this first position, the elastic plate 4111 of the control button 41 is extended into and engaged with the first-position locating hole 1172a on the fixed sleeve 117, as shown in FIG. 4, and the flat plate 32 of the control plate 30 is correspondingly maintained at a first angular position, as shown by the solid line in FIG. 6. When the flat plate 32 is set to the first angular position, most part of its side surface faces against the direction “a” in which the air flows into the air passage 115, so that a large part of the sectional area of the air passage 115 communicating with the mouthpiece 114 is blocked by the flat plate 32, and the air passage 115 shall have a reduced sectional area for the air. In other words, the air volume that is allowed to pass through the air passage 115 to be drawn in by the diver at the mouthpiece 114 is reduced, protecting the diver from being choked with air flowing at a quick speed.

FIG. 5 is a sectional view showing the control button 41 is pushed to the second position. Please refer to FIGS. 5 and 6 at the same time. When the air supply control device for air-pressure regulator according to the present invention is used at a relatively large diving depth, there is a higher air density and accordingly slower air speed. At this point, the diver may push the control button 41 for it to move along the longitudinal guide slot 1171 on the fixed sleeve 171 from the first position to the second position. At this point, the first and second pushers 411, 412 at two sides of the control button 41 are pressed against walls of the two spiral slots 311 on the annular body 31 to thereby turn the whole control plate 30. Meanwhile, the elastic plate 4111 of the control button 41 is brought to align and engage with the second-position locating hole 1172b on the fixed sleeve 117, as shown in FIG. 5, and the flat plate 32 of the control plate 30 is moved from the first angular position into a second angular position, as shown by the phantom lines of FIG. 6. When the flat plate 32 is set to the second angular position, it has an edge facing against the direction “a” in which the air flows toward the air passage 115, so that only a very small part of the air passage 115 is blocked by the flat plate 32. That is, the air passage 115 shall have an almost unchanged sectional area for the air. In other words, the air volume that is allowed to pass through the air passage 115 to be drawn in by the diver is increased, protecting the diver from breathing quickly due to a slow air speed. In the present invention, the elastic plate 4111 on the control button 41 is configured as a rearward hook. That is, the elastic plate 4111 has a front end, which moves in the same direction as that in which the control button 41 is pushed, being formed into a slant face 4112. When the control button 41 is pushed to move forward along the longitudinal guide slot 1711 on the fixed sleeve 171, the slant face 4112 of the elastic plate 4111 is in contact with a wall 1173 of the locating hole 1172, and is compressed and deformed by the wall 1173 to keep moving forward along the longitudinal guide slot 1171. When the control button 41 is moved to the second position, the elastic plate 4111 is aligned with the second-position locating hole 1172b and springs into the latter due to an elastic restoring force of the elastic plate 4111, so that the control button 41 is continuously held to the second position, as shown in FIG. 5.

When the diver returns from the larger diving depth to the smaller diving depth, he may depress the suspension arm 43 fitted around the fixed sleeve 117, so that the push block 431 provided on the suspension arm 43 is pressed against the elastic plate 4111 engaged with the second-position locating hole 1172b, causing the elastic plate 4111 to deform and move out of the second-position locating hole 1172b into the fixed sleeve 117. At this point, the elastic element 42 mounted between the channel 312 and the control button 41 elastically pushes the control button 41 from the second to the first position. Meanwhile, the first and second pushers 411, 412 on the control button 41 synchronously push the pair of spiral slots 311 on the annular body 31, so as to turn the control plate 30 from the second angular position back to the first angular position, as shown in FIG. 4 and indicated by the solid line in FIG. 6. At this point, the air passage 115 has a decreased sectional area to reduce the air volume passing through the air passage 115 within one unit of time, protecting the diver from being choked with air flowing at a quick speed.

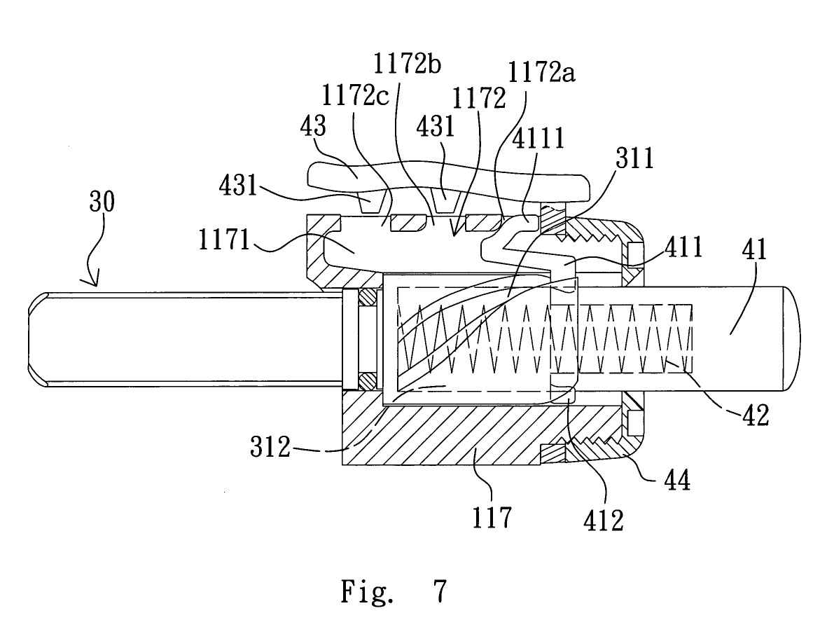

In the embodiment shown in FIGS. 4 and 5, there are two locating holes 1172a, 1172b provided on the fixed sleeve 117. However, it is understood the number of the locating holes 1172 is not limited to two. Three or more locating holes 1172 may be provided depending on the desired number of angular positions for the control plate 30. FIG. 7 is a sectional view of an air supply control device for air-pressure regulator according to a second embodiment of the present invention. In this second embodiment, there are three locating holes 1172 provided on the fixed sleeve 117, namely, a first-position locating hole 1172a, a second-position locating hole 1172b, and a third-position locating hole 1172c to set the control plate 30 to three different angular positions. With the elastic plate 4111 being engaged with different locating hole, the first and second pushers 411, 412 on the control button 41 are located at different position in the spiral slots 311, and the flat plate 32 of the control plate 30 is set to different angular position across the air passage 115 to control the air supplied via the air passage 115 to the mouthpiece 114.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An air supply control device for regulating air volume supplied from an air-pressure regulator to a diver depending on a diving depth, said air-pressure regulator including a mouthpiece communicating with an inner space of said regulator to form an air passage, said air supply control device comprising:
a fixed sleeve mounted on and extended into said air-pressure regulator to communicate an external environment with said air passage; said fixed sleeve being provided at one side with a longitudinal guide slot and a plurality of locating holes, said locating holes being arranged in the same direction as that in which said guide slot extends and being communicable with said guide slot;
a control plate including a slotted annular body and a flat plate connected to a front end of said annular body; said control plate being fitted in said fixed sleeve with said flat plate located in said air passage of said air-pressure regulator; said annular body being formed on a wall thereof with a pair of spiral slots, and defining therein a channel extending a predetermined length and communicating with said spiral slots; and
a push-button control unit for turning said control plate to different angular positions under control; said push-button control unit including:
a control button being mounted in said channel of said annular body of said control plate and provided at two sides with a first and a second pusher, which are extended into and engaged with said pair of spiral slots on said annular body; an elastic plate backward extending from a front end of said first pusher to slide in said longitudinal guide slot on said fixed sleeve, allowing said control button to slide in an extending direction of said longitudinal guide slot with said first and second pushers moving in said pair of spiral slots to rotate said control plate until said elastic plate is engaged with one of said locating holes on said fixed sleeve;
an elastic element being mounted between said channel of said annular body of said control plate and said control button of said push-button control unit, so as to provide an elastic restoring force to said control button; and
a suspension arm being fitted around the fixed sleeve, and including at least one push block provided at a position corresponding to and facing toward said locating holes, whereby when said push block is depressed, said elastic plate in said locating hole is deformed to move out of said locating hole to allow said control button to return to an initial position thereof;
whereby a diver needs only to push said control button or said suspension arm to set said flat plate of said control plate in said air passage to different angular position to thereby control the air volume supplied from said air-pressure regulator to said mouthpiece via said air passage.

2. The air supply control device as claimed in claim 1, wherein said push-button control unit further includes a cover for screwing to said fixed sleeve to hold said control plate, said control button, said elastic element, and said suspension arm in said fixed sleeve.

3. The air supply control device as claimed in claim 1, wherein said elastic plate is configured as a rearward hook, that is, said elastic plate has a front end being formed into a slant face.
